(19) United States
(12) Patent Application Publication
(10) Pub. No.: US 2003/0090485 A1
(43) Pub. Date: May 15, 2003

(54) Transition effects in three dimensional displays

(76) Inventor: John T. Snuffer, South Norwalk, CT (US)

Correspondence Address: Abraham Kasdan, Esq., Amster, Rothstein & Ebenstein, 90 Park Avenue, New York, NY, 10016, US

(21) Appl. No.: 10/293,146

(22) Filed: Nov. 12, 2002

Related U.S. Application Data
(60) Provisional application No. 60/344,662, filed on Nov. 9, 2001.

(51) Int. Cl. G06T 15/40

(52) U.S. Cl. 345/422

(57) ABSTRACT

Three-dimensional transition effects such as cross-fades between successive three-dimensional scenes are generated by manipulating depth (or “Z”) values as they transition over time in a series of transitional frames from the Z values associated with the first three-dimensional scene to the Z values associated with the second three-dimensional scene. In addition, a composition of two three-dimensional scenes is produced by first generating a pixel map of absolute differences between Z values of the two three-dimensional scenes, then blurring the pixel map, and finally blending color values of the two three-dimensional scenes according to a blending factor determined by the blurred pixel map values.

### CROSS-REFERENCE TO RELATED APPLICATION

This patent application claims the benefit of U.S. Provisional Application No. 60/344,662, filed Nov. 9, 2001.

### BACKGROUND OF THE INVENTION

The present invention relates to three-dimensional graphics techniques. More particularly, this invention relates to techniques for generating three-dimensional transition effects between scenes and image compositions formed by combining different scenes.

In creating video images or computer animations for conventional two-dimensional (“2D”) displays, various graphics techniques have been used in the prior art to smooth the transition between successive images or “scenes.” For example, the cross-fade is a commonly used transition effect in conventional two-dimensional video and film. By using the cross-fade technique, one can smoothly “fade” away the current, out-going scene and at the same time smoothly introduce the next, new scene. The cross-fade technique is generally used to reduce the effect of a jumpy transition or “cut” between scenes. However, a cross-fade of relatively long duration may also be employed in its own right to create an artistic visual effect. For example, this is often used to convey the passage of time.

A picture stream of digital video or computer animation for 2D displays consists of a sequence of encoded still frames, each made up of pixels with discrete color values. These color values may be encoded in a variety of ways using different representations of the “color space.” Commonly used color spaces are RGB (red, green and blue), HSV (hue, saturation and value) and YUV. In what follows, we shall only refer to the RGB color space representation for the sake of simplicity and by way of illustration. However, it should be noted that the present invention is equally applicable to other color space representations.

In the digital context, cross-fades are achieved by interpolating over time the color values between the two scenes starting with the original scene so that the color values smoothly transition to the color values of the next scene over a period of time, typically between a quarter of a second to three seconds. The transition may be mathematically represented as follows:

(R₃,G₃,B₃)=(R₁,G₁,B₁)×(1−f)+(R₂,G₂,B₂)×f.

(Rᵢ, Gᵢ, Bᵢ) is a color space for pixels in scene i, where i=1 corresponds to the current, out-going scene, i=2 corresponds to the next, in-coming scene, and i=3 represents the transitional, composite scene at a time corresponding to a fade factorf The fade factor f varies from 0 to 1 over the course of the cross-fade and is therefore an increasing function of time. In the simplest case of linear interpolation, the fade factor f increases linearly with time starting at f =0 at the beginning of the fade (i.e., at t=0) and increasing to f=1 at the end of the fade (i.e., t=T where T is the total duration of the fade).

Three-dimensional video or computer animation adds one additional data stream to its 2D counterpart, i.e., a data stream of depth (or “Z”) values for each pixels. Typically, a depth value for each pixel maps onto the “imaginary” Z-axis of a 2D monitor screen, with the Z value increasing as the depth recedes into the screen. Therefore, we shall refer to depth values as Z data.

It should be noted that it is possible, and often desirable, to combine the streams of color and Z data into one as RGBZ data for ease of processing and storage. Nevertheless, color data and Z data are conceptually distinct and may be separated at any time.

As noted above, to generate a cross-fade of two successive scenes, a series of transitional frames generated by a time-weighted combination of the two scenes may be displayed on a display device. In addition to such transitions between two scenes, a composition formed by combining two distinct scenes may be employed in its own right as a useful graphics and computer animation tool. Composition techniques may be used to place elements of one scene into another scene. An example would be a composition formed by combining a 3D image of a man, and a 3D scene of a forest, so that in the composite scene the man appears to be in the forest. FIG. 4 illustrates an example of a composition of two 3D scenes—a composition of an image of a man as shown in FIG. 3(A) and a scene of a rugged terrain as shown in FIG. 3(B). FIGS. 3(A) and 3(B) are two input scenes for a composition and FIG. 4 is the result of the composition.

When two 3D scenes are combined into a composition, one needs to decide which pixel from the two input scenes to display as a pixel in the output scene. Ordinarily, the pixel that is closer to the viewer is chosen. In a Z-coordinate system where the Z-axis increases in value as it recedes into the display screen, the pixel with smaller Z value is chosen and displayed:

$$\begin{matrix}( {R}_{3} , {G}_{3} , {B}_{3} , {Z}_{3} ) = ( {R}_{1} , {G}_{1} , {B}_{1} , {Z}_{1} ) & if {Z}_{1} < {Z}_{2} , or \\ = ( {R}_{2} , {G}_{2} , {B}_{2} , {Z}_{2} ) & if {Z}_{1} > {Z}_{2} ,\end{matrix}$$

where subscripts 1 and 2 correspond to input scenes and subscript 3 represents an output scene. Regardless of the type of Z-coordinate system used, the output pixel has an RGB color value of the input pixel that has the Z value closer to the viewer. This approach normally produces acceptable results for still images.

However, a composition of moving 3D images such as 3D video or computer animations often produces rather unsatisfactory results. When performing a composition of 3D images in motion, one often finds that intersecting surfaces—overlapping surfaces with identical Z values over part of their X-Y extent—have highly jagged edges if the normal vectors of the intersecting planes are almost parallel to each other. As an example illustrating this problem present in the prior art, FIG. 5 shows a close-up view of jagged edges on the intersecting surface of the dancing man and the rugged terrain in the composition of FIGS. 3(A) and 3(B). These jagged edges are produced primarily by floating-point rounding errors in the computer processor when computing the small difference between the Z values of the two input pixels. In still images, this problem is not particularly noticeable. In 3D video or computer animations, on the other hand, the problem is aggravated by highly unattractive flickering produced when the position of the jagged edges changes between successive frames of images. This phenomenon is known in the art as “Z fighting,” and results in an aesthetically unpleasing composition.

It is an object of the present invention to extend the techniques of generating transition effects to cover depth (or “Z”) values as well. These techniques can be applied to, for example, a “true” three-dimensional volumetric display system such as a multi-planar volumetric display system (MVD) as described in U.S. Pat. No. 6,377,229 to Alan Sullivan, the content of which is incorporated herein by reference in its entirety. The transition effects taught by the present invention are equally applicable to “pseudo” 3D displays which utilize depth values such as stereoscopic displays, holographic displays or headmounted displays.

It is another object of the present invention to reduce the effects of Z fighting and provide a visually attractive composition of two 3D images in motion, as in 3D video or computer animations.

### SUMMARY

The present invention is directed to a method of using depth (or “Z”) values to generate various three-dimensional transition effects. A method of transitioning between a first 3D scene and a second 3D scene is performed by first generating a series of transitional frames in which the Z values associated with the transitional frames transition over time from the Z values associated with the first 3D scene to the Z values associated with the second 3D scene and then successively displaying the transitional frames on a display system. The color values associated with the transitional frames may also transition over time from the color values associated with the first 3D scene to the color values associated with the second 3D scene in any appropriate manner to generate desired visual effects.

The present invention is also directed to a method of generating a composition of two 3D scenes in such a way that jagged edges appearing along the intersecting surface of the two 3D scenes caused by the Z fighting are blurred and smoothed out. A method of generating a composition of a first 3D scene and a second 3D scene is performed by first generating a pixel map of absolute differences between Z values of the first 3D scene and corresponding Z values of the second 3D scene, then blurring the pixel map of absolute differences, and finally blending color values of the first 3D scene and corresponding color values of the second 3D scene according to a blending factor determined by values of the blurred pixel map of absolute differences. This method may provide a visually attractive composition of two 3D images in motion, as in 3D video or computer-generated animations.

### BRIEF DESCRIPTION OF THE DRAWINGS

The above and related objects, features and advantages of the present invention will be more fully understood by reference to the following detailed description of the presently preferred, albeit illustrative, embodiments of the present invention when taken in conjunction with the accompanying drawings, which are provided to illustrate various features of the inventive embodiments. These drawings illustrate the following:

FIG. 1 illustrates 3D transition effects generated by an embodiment of the present invention.

FIG. 2 illustrates another examples of 3D transition effects generated by embodiments of the present invention.

FIGS. 3(A) and 3(B) illustrates two input source images for a composition.

FIG. 4 illustrates the composition of the images in FIGS. 3(A) and 3(B).

FIG. 5 illustrates an example of jagged edges caused by Z fighting, the problem present in the prior art.

FIG. 6 illustrates an example of edges blurred and blended according to an embodiment of the present invention.

### DETAILED DESCRIPTION OF THE PREFERRED EMBODIMENTS

The present invention extends the conventional techniques for generating transition effects based on manipulation of color data to utilize depth or “Z” data as well. Various possible ways to manipulate Z data to generate transition effects for 3D displays provide an additional degree of freedom for a 3D graphics or animation designer to create desired visual effects.

In addition, the present invention provides a 3D composition technique that can smooth the jagged edges along the intersecting surfaces of two composite scenes caused by the Z fighting as described in the Background Section.

Three Dimensional Cross-Fade Transition Effects

The conventional techniques for generating cross-fades or other transition effects for 2D video or computer animation are based on manipulation (e.g., linear interpolation) of RGB color data. In a system comprising a 3D video source (e.g., a live 3D video camera, stored 3D video sequence, computer-generated 3D animations, etc.) and a 3D display system (e.g., an auto-stereoscopic “true” 3D display system, such as a multi-planar volumetric display system, or stereoscopic pseudo-3D display system), various novel and visually attractive cross-fade transition effects can be generated by manipulating not only the RGB data, but also the depth or “Z” data. As in conventional 2D cross-fades, the 3D cross-fade techniques may be used to smooth the transition between successive scenes. Furthermore, the 3D cross-fade may be used in its own right to create desired visual effects.

One way to generate a 3D cross-fade is by interpolating the Z values of the current scene to the corresponding Z values of the next scene over a period of time:

Z₃=Z₁×(1−f)+Z₂×f,

where Z₁ and Z₂ are the depth values of the pixels in the input scenes and Z₃ is the depth values for a series of transitional frames as a function of the fade factor f. The fade factor f varies from 0 to 1 over the course of the cross-fade and is therefore a function of time. This kind of 3D cross-fade generates a visual illusion of the pixels of the current, out-going scene gradually moving along the Z axis of the 3D display system to the new positions in the next, in-coming scene.

In a 3D cross-fade, as in the conventional 2D cross-fade, the transitional RGB color values may be interpolated between the RGB values for the current, out-going scene and those of the next, in-coming scene using the same fade factor f.

(R₃,G₃,B₃,Z₃)=(R₁,G₁,B₁,Z₁)×(1−j)+(R₂,G₂,B₂,Z₂)×f,

where the subscript I represents the current, out-going scene, the subscript 2 represents the next, in-coming scene, and the subscript 3 represents the transitional frames as a function of the fade factor f. The fade factor f varies from 0 to 1 over the time period of the cross-fade. The above 3D cross-fade creates a visual illusion of the current, out-going scene, on a pixel-by-pixel basis, gradually moving in the Z axis toward the new Z axis positions of the next, in-coming scene, while at the same time the color values of the next scene gradually blend into those of the current scene by virtue of applying the same fade function f to the RGB values.

It should be noted that a 3D cross-fade technique may set the transitional RGB values in any appropriate manner by use of fade functions f that may differ from the fade function f used to transition the Z-values so as to generate desired visual effects. For instance, transitional values may be set to be:

Z₃=Z₁×(1−f)+Z₂×f, and

(R₃,G₃,B₃)=(R₂,G₂,B₂,),

where subscript 1 represents the current, out-going scene, and subscript 2 represents the next, in-coming scene, and the fade factor f varies from 0 to 1 over the course of the cross-fade. The above 3D cross-fade creates a visual illusion of the Z-values for the current, out-going scene gradually moving in the Z axis toward their new positions in the next, in-coming scene, while all of the color values immediately switch to those of the next scene at the start of the transition (f=0).

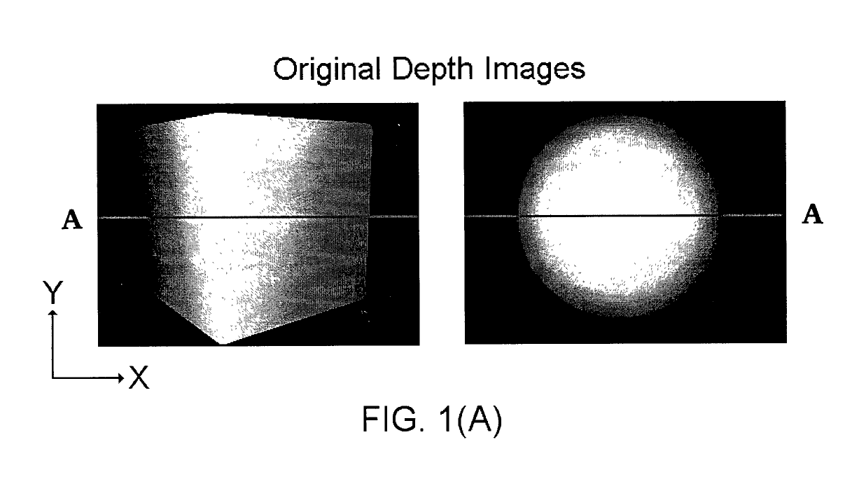

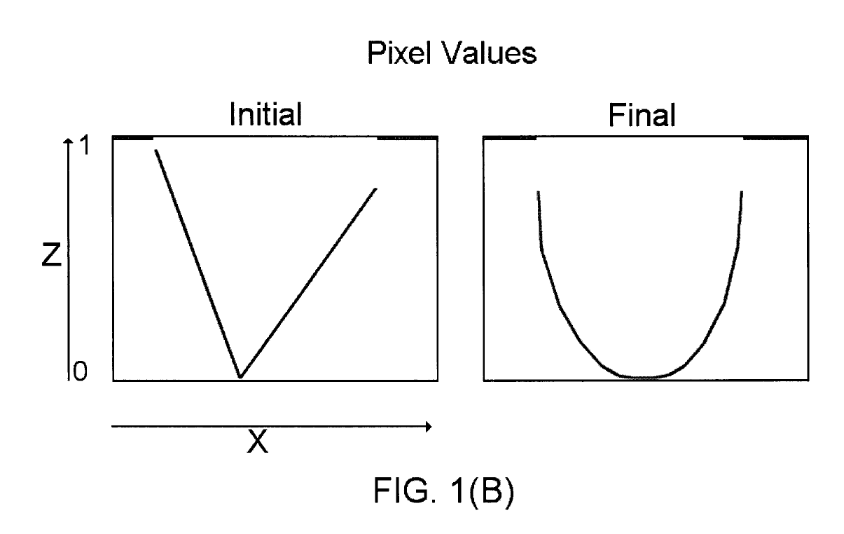

FIG. 1 illustrates the 3D cross-fade generated by the embodiment of the present invention described above. FIG. 1(A) shows original depth images of the two 3D scenes—a cube on the left and a sphere on the right. FIG. 1(B) shows pixel values Z as a function of a horizontal axis X (along the line A in FIG. 1(A)), where Z values vary from 0 (nearest to the viewer) to 1 (farthest from the viewer). FIG. 1(C) illustrates Z values in transitional frames gradually transitioning over time from the pixel values of the cube image to the pixel values of the sphere image according to the embodiment of the present invention described above.

In addition to 3D cross-fades based on intermediate values that are derived from interpolations of Z and RGB data between successive scenes, alternative 3D cross-fades giving interesting visual effects may be achieved by manipulating Z data in a variety of other ways. For example, instead of gradually moving the transitional frames from Z₁ to Z₂ as the fade factorf varies from 0 to 1, cross-fading of the Z data between successive scenes may first go to a “common plane” (e.g., an intermediate plane) at a predetermined Z value (Z=Z_{C}) at midpoint of the cross-fade (i.e., at f=0.5):

$$\begin{matrix}{Z}_{3} = {Z}_{1} \times ( 1 - 2 f ) + {Z}_{C} \times 2 f & for 0 \leq f \leq 0.5 , and \\ = {Z}_{C} \times ( 2 - 2 f ) + {Z}_{2} \times ( 2 f - 1 ) & for 0.5 \leq f \leq 1 ,\end{matrix}$$

where the subscript 1 refers to the current, out-going scene, and the subscript 2 refers to the next, in-coming scene. As before, the fade factor f varies from 0 to 1 over the course of the cross-fade. During this 3D cross-fade, all the pixels of the current scene gradually move from their original Z₁ values toward a predetermined Z position at Z_{c}, such that the outgoing 3D scene is flattened onto the Z_{c} plane halfway through the cross-fade. The next incoming scene then gradually expands out in the Z-direction to form the next scene at their proper Z positions, Z₂, by the end of the cross-fade.

For this 3D cross-fade, transitional RGB color values may be tailored in any appropriate manner by selecting either the same or different fade functions to transition the RGB values of the pixels to achieve smooth transition between successive scenes or to generate desired visual effects. By way of illustration, in the foregoing example, transitional RGB values may be set to be the RGB values of the current scene during the first half of the cross-fade (i.e., (R₃, G₃, B₃)=(R₁, G₁, B₁) for 0≦f≦0.5), and then the RGB values of the next scene during the second half (i.e., (R₃,R₃, B₃)=(R₂, G₂, B₂) for 0.5<f≦1). The transitional (R₃, G₃, B₃) values may also be linearly interpolated between the (R₁, G₁, B₁) and (R₂, G₂, B₂) values of successive scenes. Alternatively, as with Z data, transitional RGB values may be linearly interpolated between the RGB values of the current scene and predetermined RGB values during the first half of the cross-fade, and then between the predetermined RGB values and the RGB values of the next scene during the second half of the fade transition.

Another alternative 3D cross-fade technique is a variation of the above-described technique for cross-fading Z data to and from a common plane. Instead of cross-fading the Z data to and from a common plane, one may also cross-fade the Z data through a predetermined Z-map or depth pattern (i.e., predetermined, different Z's for each pixel). In this, the transitional effect can be described by the following questions:

$$\begin{matrix}{Z}_{3} = {Z}_{1} \times ( 1 - 2 f ) + Z ( X , Y ) \times 2 f & for 0 \leq f \leq 0.5 , and \\ = Z ( X , Y ) \times ( 2 - 2 f ) + {Z}_{2} \times ( 2 f - 1 ) & for 0.5 \leq f \leq 1 ,\end{matrix}$$

where the subscript 1 represents the current, out-going scene, and the subscript 2 represents the next, in-coming scene. Z(X, Y) defines the predetermined map or pattern of Z's for different (X, Y) pixel locations. The fade factor f varies from 0 to 1 over the course of the cross-fade. Accordingly, halfway through the cross-fade, the pixels will form the pattern Z(X, Y) along the Z-axis. This pattern could be, for example, of a simple abstract form (e.g., checker pattern) or a functional form (e.g., company logo or something connected with the content of the images). By the end of the cross-fade, this pattern will have transformed into the next scene. Again, transitional RGB values can be tailored in any appropriate manner to achieve smooth transition between successive scenes or to generate desired visual effects.

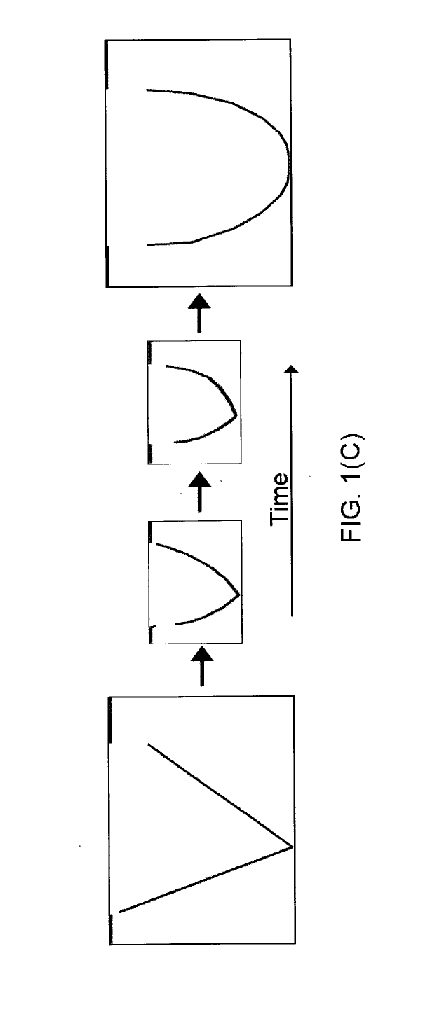

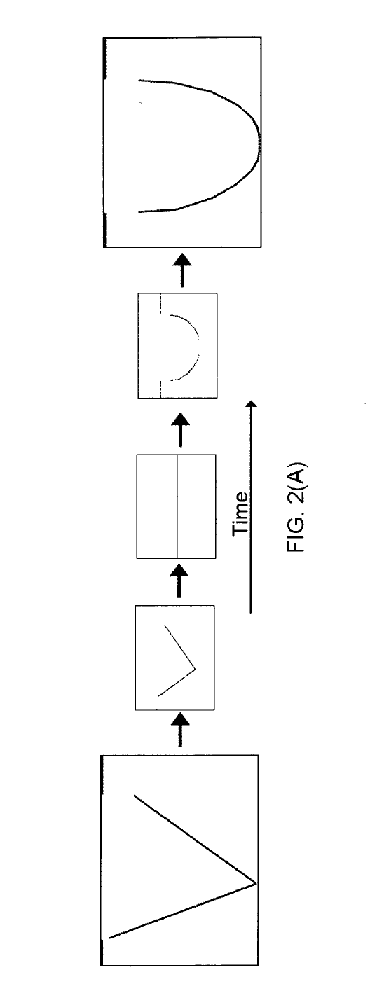

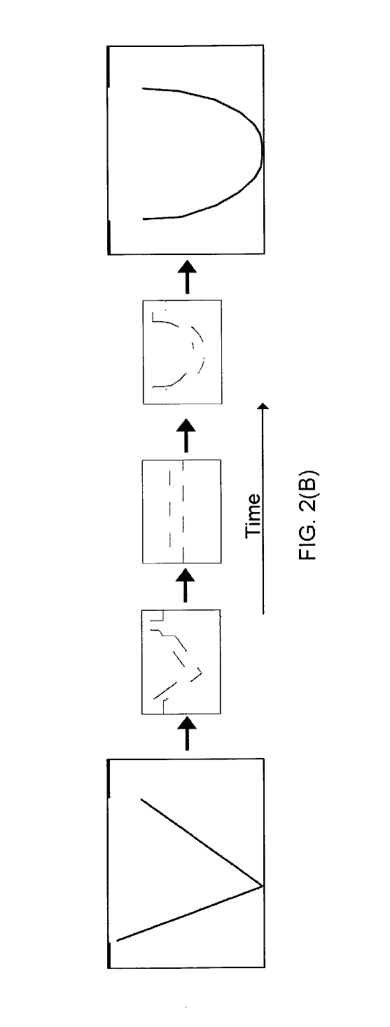

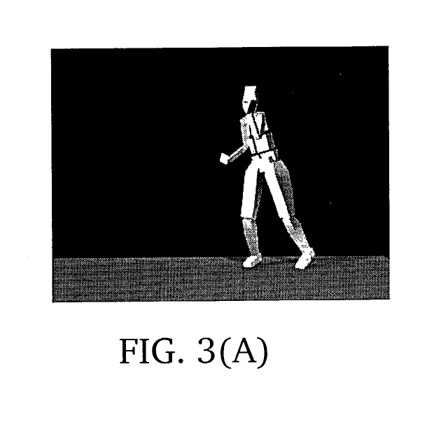

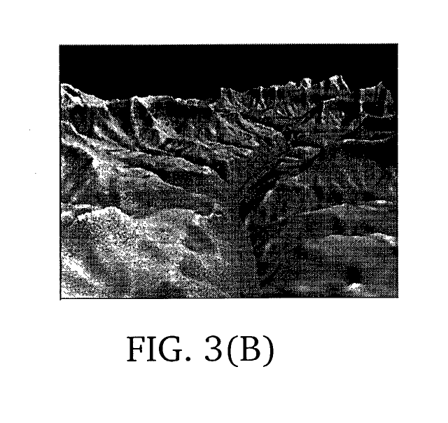

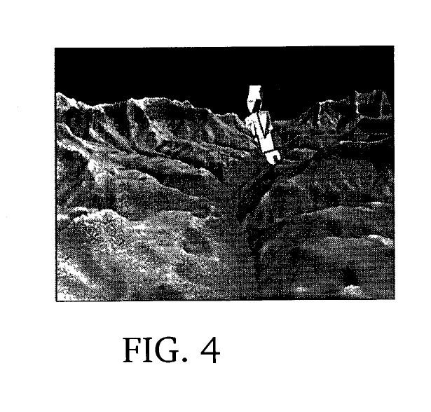

FIG. 2 illustrates examples of cross-fading Z values to and from a common plane at a predetermined Z value and to and from a map of predetermined Z values. FIG. 2(A) illustrates Z values in transitional frames gradually transitioning over time from the pixel values of the cube image (See FIG. 1(B)) to a predetermined Z value and then to the pixel values of the sphere image according to the embodiment of the present invention described above. FIG. 2(B) illustrates Z values in transitional frames gradually transitioning over time from the pixel values of the cube image to a predetermined checker-pattern Z map and then to the pixel values of the sphere image according to the embodiment of the present invention described above.

Yet another alternative embodiment of 3D cross-fade can be performed by cross-fading the Z data of successive scenes through different planes for the current, out-going scene and the next, in-coming scene. This is another variation of the 3D cross-fade through a common plane Z_{C}. For example, the common plane for the current, out-going scene may be set at Z_{BACK}, a Z-value very far away from the viewer, and the common plane for the next, in-coming scene may be set at Z_{FRONT}, a Z value very close to the viewer:

$$\begin{matrix}{Z}_{3} = {Z}_{1} \times ( 1 - 2 f ) + {Z}_{BACK} \times 2 f & for 0 \leq f \leq 0.5 , and \\ = {Z}_{FRONT} \times ( 2 - 2 f ) + {Z}_{2} \times ( 2 f - 1 ) & for 0.5 \leq f \leq 1 ,\end{matrix}$$

where the subscript 1 represents is the current, out-going scene, and the subscript 2 represents the next, in-coming scene. The fade factor f varies from 0 to 1 over the course of the cross-fade. In a Z-coordinate system where Z values increase as the Z axis recedes into the screen, Z_{FRONT}<Z_{BACK} During the first half of this 3D cross-fade, the current, out-going scene gradually recedes from Z₁ to the back (Z_{BACK}). At the midpoint of the cross-fade, the next, in-coming scene appears from the front (Z_{FRONT}) and gradually moves to Z₂ This kind of 3D cross-fade is analogous to a class of 2D transition effects known in the art as “wipes.” Again, transitional RGB values can be tailored in any appropriate manner to achieve smooth transition between successive scenes or to generate desired visual effects.

Yet another alternative embodiment of a 3D cross-fade involves a composition of two separate transitional frames evolving in time at the same time. One subset of transitional frames is the current, out-going scene gradually receding from Z₁ to the back (Z_{BACK}). Another subset of transitional frames is the next, in-coming scene gradually coming toward the viewer from the back (Z_{BACK}) to Z₂.

Z_{A}=Z₁×(1−f)+Z_{BACK}×f for 0≦f≦1, and

Z_{B}=Z_{BACK}×(1−f)+Z₂×f for 0≦f≦1,

where the subscript 1 represents the current, out-going scene, and the subscript 2 represents the next, in-coming scene. The fade factor f varies from 0 to 1 over the course of the cross-fade. The RGB values for each transitional frames may keep the RGB values associated with Z₁ and Z₂, respectively, or may be set in an appropriate manner to indicate distance (e.g., the out-going scene becoming darker as it recedes into the back, and vice versa for the in-coming scene). When a composition of these two transitional frames associated with Z_{A} and Z_{B} is performed, one can observe the out-going scene gradually receding away from the viewer to the back plane Z_{BACK} and, during this recession, the in-coming scene suddenly bursting in through the out-going scene and moving to Z₂.

Three Dimensional Composition Techniques

Another objective of the present invention is to overcome the effects of Z fighting and provide a visually attractive composition of two 3D images in motion, as in 3D video or computer-generated animations. More specifically, the present invention addresses a 3D composition technique that can smooth the jagged edges along the intersecting surfaces of two moving scenes caused by Z fighting (as described in the Background Section).

The first step for the 3D composition technique that can alleviate the problem of Z fighting is to create a two-dimensional pixel map of the absolute difference between the Z values, ∥Z₁−Z₂∥, of the two input pixels at each (X, Y) pixel location, one pixel being from the first scene and the second pixel being from the second scene. A large constant integer then multiplies the absolute difference map ∥Z₁−Z₂∥ to increase the dynamic range of the averaging (or blurring) to be described below, thereby reducing the sensitivity of the potential errors associated with the absolute difference in Z values. It is computationally efficient to use a power of 2 as the constant integer, since the multiplication and division may then be accomplished using bit-shifting techniques. By way of illustration, 256 (=2⁸) will be used as the constant, but this is certainly an arbitrary choice and any large integer may accomplish the same objective.

Next, the scaled two-dimensional difference map, ∥Z₁−Z₂∥×256, is then blurred by a standard method based on, for example, a gaussian function or a convolution kernel. By blurring, one can essentially spread the impact of a rounding error at one pixel over its neighboring pixels, thereby reducing the impact of rounding errors on the pixel. This can be achieved by replacing the value for each pixel in the scaled two dimensional difference map with the average of the map values over the pixel and its neighboring pixels. For example, elements of the scaled two-dimensional difference map, ∥Z₁−Z₂∥×256, for a pixel and its surrounding eight neighboring pixels (forming a 3×3 matrix with the pixel value at the center) may be multiplied by a convolution kernel such as:

$$( \begin{matrix}1 & 2 & 1 \\ 2 & 20 & 2 \\ 1 & 2 & 1\end{matrix} ) .$$

The resulting matrix is then normalized by dividing it by the magnitude of the convolution kernel matrix. This convolution kernel produces a weighted average over the neighboring pixels with most weight on the center pixel. Another example of a convolution kernel would be a 3×3 matrix in which all of its matrix elements are 1. This will generate an equally weighted average over the neighboring pixels. A person skilled in the art will therefore appreciate the fact that blurring of the difference map may be achieved by using various types of convolution kernels or other methods.

Finally, the 3D composition is completed by blending of the RGB color values from the two input pixels. Blending factors P are derived from the scaled and blurred difference map values, ΔZ=Blur(∥Z₁−Z₂∥×256):

β=0.5+(ΔZ=0.5)/(S×256),

where S=Z_{MAX}−Z_{MIN} is a scaling factor dependent on the Z-coordinate system. If Z varies between 0 and 1, then S=1; if Z varies between 0 and 20, then S=20. The blending function for the RGB values is scaled in such a way that, for S 1, ΔZ=0 results in a 50% blend of the RGB values from each of the source pixels, ΔZ=128 results in 75% blend from the nearest pixel, and ΔZ=256 results in 100% blend from the nearest pixel:

$$\begin{matrix}{RGB}_{BLEND} = {RGB}_{1} \times β + {RGB}_{2} \times ( 1 - β ) & if {Z}_{1} < {Z}_{2} , \\ = {RGB}_{1} \times ( 1 - β ) + {RGB}_{2} \times β & if {Z}_{1} > {Z}_{2} , or \\ = {RGB}_{1} \times 0.5 + {RGB}_{2} \times 0.5 & if {Z}_{1} = {Z}_{2}\end{matrix}$$

where RGBᵢ=(Rᵢ, Gᵢ, Bᵢ). Here, we assumed that Z values increase as the Z axis recedes from the viewer into the screen. In a 3D composition, the Z values nearest to the viewer are ordinarily chosen as the final output Z values.

As way of illustration, let us for the moment assume that Z varies from 0 (nearest to the viewer) to 1 (farthest from the viewer) and disregard the effect of blurring on the difference map values given in the following example. If the color and depth values (R, G, B, Z) of two input pixels are (10, 0, 0, 0.1) and (0, 0, 0, 0.1), the output value for the 3D composition in accordance with the above embodiment would be (5, 0, 0, 0.1). On the other hand, a 3D composition of the input pixels of(10, 0, 0, 0.1) and (0, 0, 0, 0.6) would result in an output of (7.5, 0, 0, 0.1).

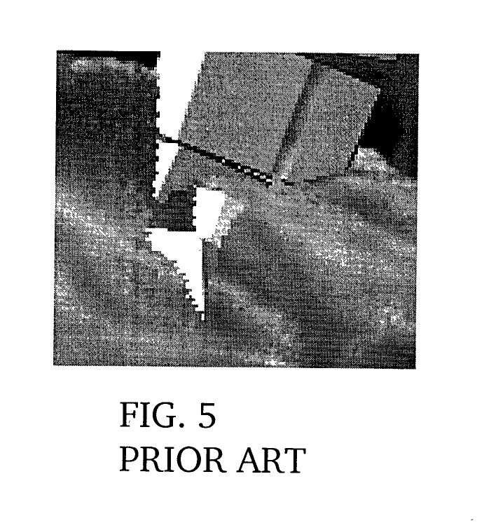

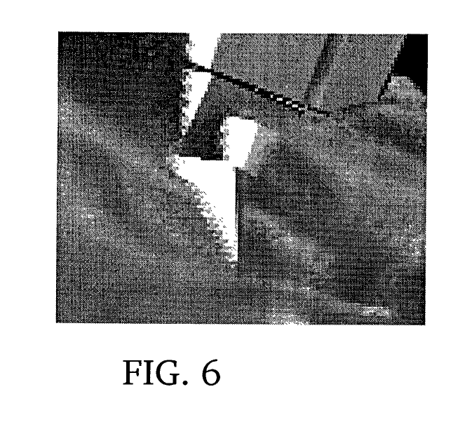

FIG. 6 shows an example of improvement in visual effect achieved by the 3D composition technique in accordance with the present invention. The jagged edges along the intersecting surfaces of two images as shown in FIG. 5 have been blurred and smoothed out.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

We claim:

1. A method of transitioning between a first three-dimensional scene and a second three-dimensional scene having pixels described by color and depth (Z) values, comprising the steps of:
generating a series of transitional frames in which the Z values (Z₃) associated with said transitional frames transition over time from the Z values (Z₁) associated with said first three-dimensional scene to the Z values (Z₂) associated with said second three-dimensional scene; and
successively displaying said series of said transitional frames.

2. The method of claim 1, wherein the color values associated with said transitional frames transition over time from the color values associated with said first three-dimensional scene to the color values associated with said second three-dimensional scene.

3. The method of claim 1, wherein said Z₃ values are computed to be a time-weighted average of said Z₁ values and said Z₂ values.

4. The method of claim 3, wherein the color values associated with said transitional frames transition over time from the color values associated with said first three-dimensional scene to the color values associated with said second three-dimensional scene.

5. The method of claim 1, wherein said Z₃ values transition from said Z₁ values to a single predetermined Z value and from said single predetermined Z value to said Z₂ values.

6. The method of claim 5, wherein the color values associated with said transitional frames transition over time from the color values associated with said first three-dimensional scene to the color values associated with said second three-dimensional scene.

7. The method of claim 1, wherein said Z₃ values transition from said Z₁ values to a map of predetermined Z values and from said map of predetermined Z values to said Z₂ values.

8. The method of claim 7, wherein the color values associated with said transitional frames transition over time from the color values associated with said first three-dimensional scene to the color values associated with said second three-dimensional scene.

9. The method of claim 1, wherein said Z₃ values transition from said Z₁ values to a first predetermined Z value and then transition from a second predetermined Z value to said Z₂ values.

10. The method of claim 9, wherein the color values associated with said transitional frames transition over time from the color values associated with said first three-dimensional scene to the color values associated with said second three-dimensional scene.

11. The method of claim 1, wherein said step of generating said series of said transitional frames comprises the steps of:
generating a first subset of transitional frames in which the Z values transition from said Z₁ values to a predetermined large Z value;
generating a second subset of transitional frames in which the Z values transition from said predetermined large Z value to said Z₂ values; and
generating a composition of said first subset and said second subset of transitional frames to generate a final set of said transitional frames for display.

12. The method of claim 11, wherein the color values associated with said transitional frames transition over time from the color values associated with said first three-dimensional scene to the color values associated with said second three-dimensional scene.

13. A method of generating a composition of a first three-dimensional scene and a second three-dimensional scene, comprising the steps of:
generating a pixel map of absolute differences between depth (Z) values of said first three-dimensional scene and corresponding Z values of said second three-dimensional scene;
blurring said pixel map of absolute differences; and
blending color values of said first three-dimensional scene and corresponding color values of said second three-dimensional scene according to a blending factor determined by said blurred pixel map of absolute differences.

14. The method of claim 13, wherein said step of generating said pixel map of absolute differences further comprises the step of scaling said pixel map of absolute differences.

15. The method of claim 14, wherein said scaling step comprises the step of multiplying said pixel map of absolute differences by a large integer.

16. The method of claim 13, further comprising the steps of:
comparing said Z values of said first three-dimensional scene and said corresponding Z values of said second three-dimensional scene; and
displaying said blended color values of only those pixels having Z values closer to the viewer.

17. The method of claim 13, wherein said blurring step comprises the steps of:
calculating normalized averages of said absolute differences over each pixel and its corresponding neighboring pixels; and
replacing said pixel map of absolute differences by a pixel map of said normalized averages.

18. The method of claim 13, wherein said blurring step comprises the steps of:
calculating for each pixel a product of said pixel map of absolute differences and a predetermined convolution kernel; and
replacing said pixel map of absolute differences by said product.

19. The method of claim 13, wherein said blending factor is 50% (0.5) when a value of said blurred pixel map is zero.

20. The method of claim 13, wherein said blending factor is an increasing function of said blurred pixel map value.
